(19) United States
(12) Patent Application Publication
(10) Pub. No.: US 2010/0128852 A1
(43) Pub. Date: May 27, 2010

(54) Detector Characterization and Calibration

(75) Inventors: Eugene Yamamoto, Long Beach, CA (US); Hal Franklin, San Ramon, CA (US); John P. Alioto, San Ramon, CA (US); Matthew Alioto, Dublin, CA (US)

Correspondence Address: FOLEY & LARDNER LLP, 975 PAGE MILL ROAD, PALO ALTO, CA, 94304, US

(73) Assignee: VeriTainer Corporation

(21) Appl. No.: 12/277,241

(22) Filed: Nov. 24, 2008

(51) Int. Cl. G01D 18/00

(52) U.S. Cl. 378/207; 250/252.1

(57) ABSTRACT

Characterization, calibration and gain stabilization of gamma ray detectors are carried out using one or more spectral features that are present in the background radiation. Such a spectral feature may be the spectral peak associated with Potassium-40 nuclide. The disclosed methods, apparatus and computer program products enable uninterrupted operation of gamma ray detection systems, while eliminating the costs associated with the procurement and integration of external reference sources into these systems, and without compromising the sensitivity of the detection system.

### FIELD OF THE INVENTION

The present invention relates generally to gamma ray detectors. More specifically, this invention relates to methods, apparatus and computer program products for characterization, calibration and gain stabilization of gamma ray detectors.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

One of the basic transport mechanisms of the modern global economy is containerized shipping. Through seaports and border crossings, shipping containers freely move in and out of the nations of the world with little or no inspection of their contents. Various mechanisms have been developed to detect and avert the potential delivery of nuclear material by stealth in a shipping container destined for a particular population center. A number of such detection systems rely on the detection by various types of radiation detection devices of gamma rays emitted by radioactive or fissile material in a shipping container. These detection devices may additionally, or alternatively, rely on the detection of neutrons emitted by radioactive or fissile material to detect the presence of such material within a closed container.

Detector calibration and stability are two crucial factors for proper operation of radiation detection systems. Without proper calibration, data collected by the detector cannot be analyzed effectively. Without detector stability, the analysis of data collected by the detector cannot be performed consistently or predictably. Detector characterization, particularly the measurement of detector resolution, is also important, as poor detector resolution obscures detail and impedes data analysis, while degrading detector resolution reduces consistency over time. It is therefore useful to track detector resolution in order to identify when a detector is no longer operating within desired specifications.

Detector characterization, calibration and gain stabilization is typically performed by exposing the detector to radiation from a source with known measurement characteristics. More specifically, a typical calibration procedure involves placing a reference source with predetermined energy characteristics in the vicinity of a detector to allow spectral energy measurements of the reference source. The measured data is then compared with the expected energy spectrum of the reference source, and the detector gain is adjusted, if necessary, to provide a match between the measured and expected energy spectra. Once proper gain is established, detector resolution may be determined by inspection.

The above-described technique, however, is not suitable for applications where the introduction of a reference source is not practicable. Aside from the extra cost and space associated with integrating such an external source into the detector device, the reference radiation source may interfere with detector measurements. This interference, which is usually manifested as background radiation and ‘extra counts,’ inevitably lowers the overall sensitivity of the detector. Furthermore, if the reference source is not integrated into the detector device, calibration must be conducted while the detector is taken off-line. Such interruptions may not be acceptable in applications where continuous detector operation is desired or required. An external reference source that is kept separate from the detector device poses additional operational and logistical difficulties, as well. For example, the detection device may need to be removed from the field and sent to a different location where the reference source resides. Alternatively, the reference source may need to be kept at a proper distance away from the detector and/or isolated with proper shielding.

### SUMMARY OF THE INVENTION

The present invention relates to methods, apparatus and computer program products that enable calibration, characterization and gain stabilization of gamma ray detectors without requiring an additional reference source. These methods, apparatus and computer program products enable uninterrupted operation of the detectors while eliminating the costs associated with the procurement and integration of external reference sources into the detection system.

One embodiment of the present invention relates to a method for calibrating a gamma ray detector, comprising the receipt of information corresponding to gamma ray energies collected by the detector from background radiation, analyzing the information to determine if black-listed properties are present, and, if one or more black-listed properties are present, disregarding some or all the information, comparing the energy spectrum associated with the information with one or more expected spectral features associated with the background radiation, and calibrating the detector in accordance with the comparison.

As used herein, “black-listed properties” refers to the detected properties that may interfere with and/or distort the spectral characteristics associated with one or more spectral features of the background radiation that may be utilized to effect detector calibration. For example, black-listed properties may include, but are not limited to, one or more spectral features that are associated with one or more known nuclides with interfering spectral characteristics, an anomalous gamma count rate, an anomalous neutron count rate, and the presence of a spectral peak feature that is not associated with known nuclides.

As used herein, “nuclide” may refer to a species of atom characterized by the constitution of its nucleus, and hence, by the number of protons, the number of neutrons, and the energy content. For example, the various types of nuclides of a particular chemical element may include, but are not limited to, nuclides with equal proton numbers but different neutron numbers (also known as Isotopes), nuclides with equal mass numbers (i.e., total number of protons and neutrons) but different number of protons (also known as Isobars), nuclides of equal neutron numbers but different proton numbers (also known as Isotones), nuclides that have equal proton numbers and equal mass numbers, but differ in energy content (also known as Isomers), unstable nuclides that are radioactive (also known as radionuclides), as well as their decay products or ‘daughters’ (also known as radiogenic nuclides).

According to one aspect of the present invention, the background radiation comprises a spectral feature associated with the Potassium-40 nuclide, and in a different aspect, the information comprises at least one of a count or an intensity value. In another aspect, the spectral feature comprises a spectral peak at 1461 keV. In a different aspect, the detector is located on a crane configured to move containers.

According to a different aspect of the present invention, the black-listed properties comprise at least one of: one or more spectral features associated with one or more known nuclides with interfering spectral characteristics, an anomalous gamma count rate, an anomalous neutron count rate, and the presence of a spectral peak feature not associated with known nuclides. In another aspect, the one or more known nuclides comprise Cobalt-60 and decay daughters of Uranium-238. In yet a different aspect, the presence of the black-listed properties is determined in accordance with one or more user-defined thresholds.

According to another aspect of the invention, the method further comprises analyzing the information to determine if white-listed properties are present, and, if one or more white-listed properties are present, retaining the information.

As used herein, “white-listed properties” may refer to the detected properties that do not interfere and/or distort the spectral characteristics associated with one or more spectral features of the background radiation that may be utilized to effect detector calibration. For example, white-listed properties may include, but are not limited to, spectral features associated with ubiquitous and/or common nuclides, gamma count rates and/or neutron count rates that are within an acceptable range.

In a different aspect of the present invention, the method further comprises fitting the information to one or more statistical distributions to obtain one or more parameters associated with the fitted distribution, and adjusting the gain of the detector if at least one parameter associated with the fitted distribution is more than a configured number of standard deviations from the a parameter associated with the expected spectral feature. In one aspect, the parameter associated with the fitted distribution comprises a centroid, and the parameter associated with the expected spectral feature comprises a location of a peak. According to a different aspect, the statistical distribution comprises a Gaussian foreground distribution with an exponential background distribution.

According to a different aspect of the present invention, the method further comprises producing filtered information by low-pass filtering the information prior to the fitting, fitting the filtered information to one or more statistical distributions to obtain an initial fit, fitting the unfiltered information in accordance with one or more parameters associated with the initial fit to obtain re-fitted information, and confirming the validity of the one or more parameters associated with the initial fit by verifying that the differences between the one or more parameters associated with the initial fit and the one or more parameters associated with the re-fitted information are within pre-determined uncertainty bounds. In yet another aspect, at least one parameter associated with the fitted distribution comprises a full-width at half-maximum value. In another aspect, the method further comprises performing one or more consistency checks to confirm the existence one or more relationships between one or more additional features of the background radiation and the fitted distribution. In still another aspect of the present invention, the method further comprises fitting the information to one or more statistical distributions to obtain a first gain value associated with the fitted distribution, receiving new information corresponding to gamma ray energies collected by the detector from the background radiation, fitting the new information to the one or more statistical distributions to obtain a second gain value associated with the newly fitted distribution, and confirming the stability of the detector if the difference between the first and the second gain values is within a predetermined tolerance. In one variation, the new information may comprise at least one of a count or an intensity value.

Another embodiment to the present application relates to an apparatus for calibrating a gamma ray detector, comprising a receiver configured to receive information corresponding to gamma ray energies collected by the detector from background radiation, an analyzer configured to analyze the information to determine if black-listed properties are present, and if one or more black-listed properties are present, disregarding some or all the information, a comparator configured to compare the energy spectrum associated with the information with one or more spectral features associated with the background radiation, and calibration means configured to calibrate the detector in accordance with the comparison.

A different embodiment of the present application relates to a computer program product, embodied on a computer-readable medium, for calibrating a gamma ray detector, comprising a computer program for receiving information corresponding to gamma ray energies collected by the detector from background radiation, a computer program for analyzing the information to determine if black-listed properties are present, and if one or more black-listed properties are present, disregarding some or all the information, a computer program for comparing the energy spectrum associated with the information with one or more spectral features associated with the background radiation, and a computer program for calibrating the detector in accordance with the comparison.

These and other advantages and features of various embodiments of the present invention, together with the organization and manner of operation thereof, will become apparent from the following detailed description when taken in conjunction with the accompanying drawings. The entire disclosures of all patents and references cited throughout this application are incorporated herein by reference in their entirety.

### BRIEF DESCRIPTION OF THE DRAWINGS

Embodiments of the invention are described by referring to the attached drawings, in which:

FIG. 1 illustrates an exemplary hoist and shipping container accommodating a gamma ray detector that may be used in accordance with various embodiment of the present invention;

FIG. 2(A) illustrates an exemplary energy spectrum associated with gamma ray data that is collected over a long detection period;

FIG. 2(B) illustrates an exemplary energy spectrum associated with gamma ray energies;

FIG. 3 illustrates a flow diagram for calibrating a detector in accordance with an exemplary embodiment of the present invention;

FIG. 4 illustrates a flow diagram for gain computation in accordance with an exemplary embodiment of the present invention;

FIG. 5(A) illustrates the energy spectrum of data collected in accordance with an exemplary embodiment of the present invention;

FIG. 5(B) illustrates the energy spectrum corresponding to the data in FIG. 5(A) that is filtered in accordance with an exemplary embodiment of the present invention;

FIG. 6 illustrates a full-width at half-maximum (FWHM) associated with Potassium-40 peak in accordance with an exemplary embodiment of the present invention; and

FIG. 7 illustrates an energy spectrum obtained from a detector that has been calibrated in accordance with an exemplary embodiment of the present invention.

### DETAILED DESCRIPTION OF PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

Calibration, characterization, and gain stabilization are crucial factors for proper operation and maintenance of gamma ray detectors. While these operations ensure the validity, predictability and/or repeatability of the detection results, they must be carried out efficiently and expeditiously in order to minimize unnecessary interruptions in the detector operation, as well as to avoid logistical and operational difficulties associated with the transportation and utilization of external calibration sources.

In applications involving the inspection of shipping containers that leave and/or enter sea ports and border crossings, continuous and efficient operation of detectors is of critical importance. As of 2004, 30,000 shipping containers entered the United States every day, and 200 million containers moved across the world through seaports, over the roads and by railroad in a year. Due to the sheer volume and flow of such magnitude, any interruptions in the inspection process, can result in either the suspension of the flow of containers, with severe economic consequences, or may cause a portion of all containers not to be inspected, with potentially disastrous consequences if stealth nuclear material is smuggled undetected.

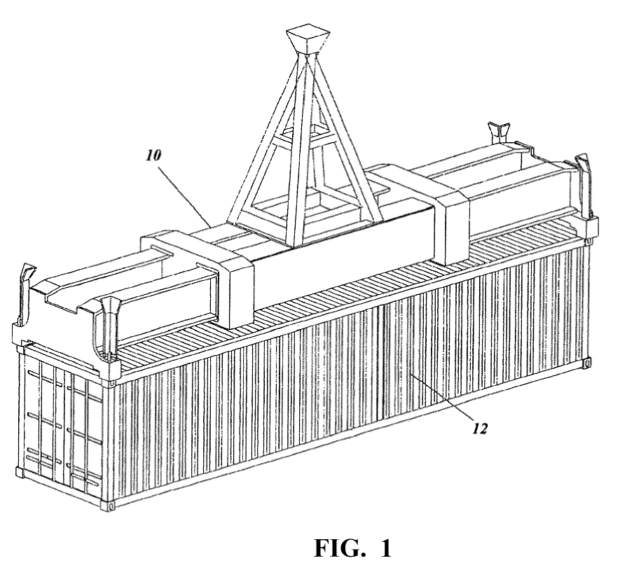

To facilitate the inspection of shipping containers, radiation detection devices may be incorporated into the crane assembly that is used to lift and move these containers. Typically, the container crane includes a hoist attachment that engages the shipping container. FIG. 1 illustrates an example hoist attachment 10 and a container 12 being carried by the hoist attachment 10. A fissile or radioactive material detection device may be mounted to the hoist attachment such that as the shipping container is being engaged, the detection device is brought into proximity to the container so that the presence of fissile or radioactive material may be detected during the loading or unloading of the shipping container from a shipping vessel. For further details regarding such detection systems, reference may be made to the U.S. Pat. Nos. 6,768,421 and 7,026,944, as well as the U.S. patent application Ser. No. 11/605,529, all of which are commonly-owned by the assignee of the present application. According to an embodiment of the present invention, calibration, characterization and gain stabilization for a detector, such as the one incorporated into a hoist attachment of a crane assembly, may be conducted without the use of an additional calibration source, while minimizing any interruptions to the continuous operation of the detection system, and without compromising the sensitivity of the detection system that is often associated with the presence of an external calibration source.

A popular method for the detection of gamma-rays energies and producing a gamma energy spectrum involves the use of crystal scintillators. Scintillators can be made of a variety of materials, depending on the intended applications. The most common scintillators used in gamma-ray detectors, which are made of inorganic materials, are usually an alkali halide salt, such as Sodium Iodide (NaI) or Cesium Iodide (CsI). When gamma rays interact with these crystals, the scintillating crystal emits light that is proportional to the gamma ray energy deposited in the crystal. The produced light may then be collected by one or more photomultiplier tubes (PMTs) that are optically connected to the scintillator. The PMT produces analog electrical signals (i.e., voltage pulses) that may be read out by the electronic circuitry, and further processed. Such processing may include, for example, amplification, analog-to-digital conversion, pulse shaping and other signal processing steps. The results of these transformations arc recorded using a multichannel analyzer (MCA). The multichannel analyzer sorts the detected pulses into a specific number of bins according to their signal values (e.g. pulse height). These bins represent the “channels” in the energy spectrum. Each time a pulse is detected, the count associated with a channel corresponding to the detected pulse height may be incremented. As such, the MCA records the distribution of incoming pulse heights, and thus, the gamma ray energies that are incident on the detector. This information may be stored locally in a memory buffer and retrieved periodically for analysis and/or for permanent storage on a different memory device. Once the data is retrieved, the MCA buffer may be purged or overwritten. The number of channels in the MCA may be varied based on the desired resolution and the energy range of interest. For example, the number of channels may be selected from a group consisting of 512, 1024, 2048, 4096 or other suitably selected number of channels. These and other features associated with gamma ray detectors and MCAs are well known in the art and will not be discussed in further detail.

Since the above-described MCA channel numbers are proportional to the gamma energies incident on the detectors, the channel scale may be converted into an energy scale using an appropriate calibration technique. In order to conduct a proper calibration, however, one must identify and account for detector's non-linear response to incident gamma energies. For example, assuming that a gamma ray with energy X produces a detector output signal A, a gamma of energy 2X may not produce a signal of strength 2A. It is therefore important to calibrate the detector before and during its deployment into the field. The detector's energy calibration may be determined and parameterized by a second order polynomial, as illustrated by the following exemplary equation:

G=ax²+bx+c (1)

Where, G represents the incident gamma energy, x represents the channel number, and a, b, and c represent constants associated with the second-, first- and zero-order terms, respectively. It should be noted that the above-described second-order equation only illustrates an exemplary equation that may be used to characterize detector's energy response. It is therefore entirely possible to characterize the detector's response using other equations containing a different number of variables, including, for example, equations with third or fourth degree terms. Referring back to Eq. (1), and assuming that the second-order coefficient, a, and the constant c, are fixed, the first-order (i.e., linear) term remains as the only adjustable term. For example, this term may be adjusted electronically by tuning the Fine Gain control of the detector. In addition to the initial calibration and characterization of the detector, periodic measurements of the gain (linear term) may also be necessary due to the dependency of the detector performance on temperature, as well as a longer term overall gain loss due to the aging of the high voltage detector components. In addition, periodic measurements of the constant term, c, and second-order coefficient, a, may also be conducted to properly calibrate and characterize the detector performance as the detectors age.

Based on the above-noted assumptions regarding the various coefficients in Eq. (1), the energy calibration of the detector may be validly conducted when at least one reference point along the calibration curve is known. In accordance with an embodiment of the present invention, an energy peak feature from a naturally occurring nuclide, such as Potassium-40, K40, may be used as a reference peak to effect and maintain detector calibration. The nuclide K40 has a single dominant energy peak at 1461 keV, which makes it an ideal candidate for use as a reference. Potassium is an element that is naturally present in the ground everywhere (e.g., 2.9% elemental abundance in the Earth's crust by mass), and thus the spectral features associated with K40 appear everywhere as part of the background radiation. As such, in accordance with an example embodiment of the present application, K40 peak may be advantageously used to eliminate the need for external calibration sources, while allowing continuous operation of the detector in the field.

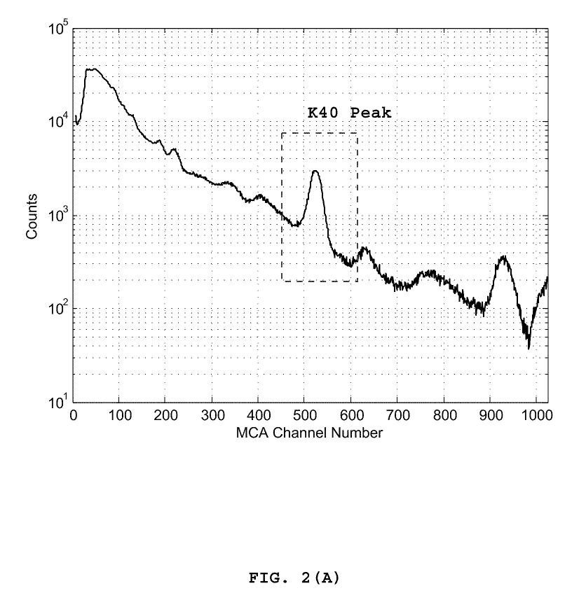

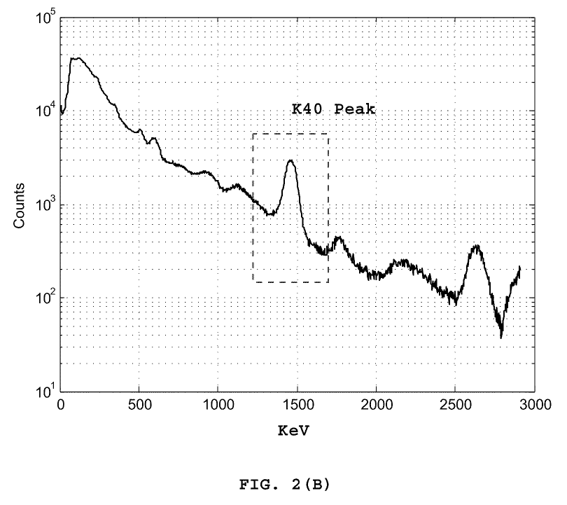

FIG. 2(A) illustrates an example energy spectrum collected using 3″×6″ Sodium Iodide detectors at a port location. In this figure, the gamma ray counts associated with 1024 channels are plotted. The large amount of data collected reduces statistical variations in the data and facilitates graphical presentation of various energy spectrum features. FIG. 2(A) further illustrates the energy peak feature associated with K40, which is enclosed in a dashed rectangle. FIG. 2(B) illustrates the same exemplary energy spectrum that has been plotted in terms of keV. In accordance with an example embodiment of the present invention, the location of K40 peak feature that appears as part of the background radiation may be used as a reference to allow gain calibration and characterization of the detectors that operate anywhere on land or in close vicinity of land.

It should be noted that the various embodiments of the present invention apply to any detector that characterizes energy quanta by amplitude, thus providing information regarding the intensity and/or energy of the source of the gamma rays. As such, it suffices to obtain a large enough sample population of gamma hits and their associated energy/intensity levels that can be used to infer the current gain of a functioning detector (and therefore adjust it to a canonical level to suit the desired needs). The principles of the present invention may therefore be applied to any graph of prevalence by energy/intensity in any scale, provided there is a recognizable and regress-able pattern in the background radiation.

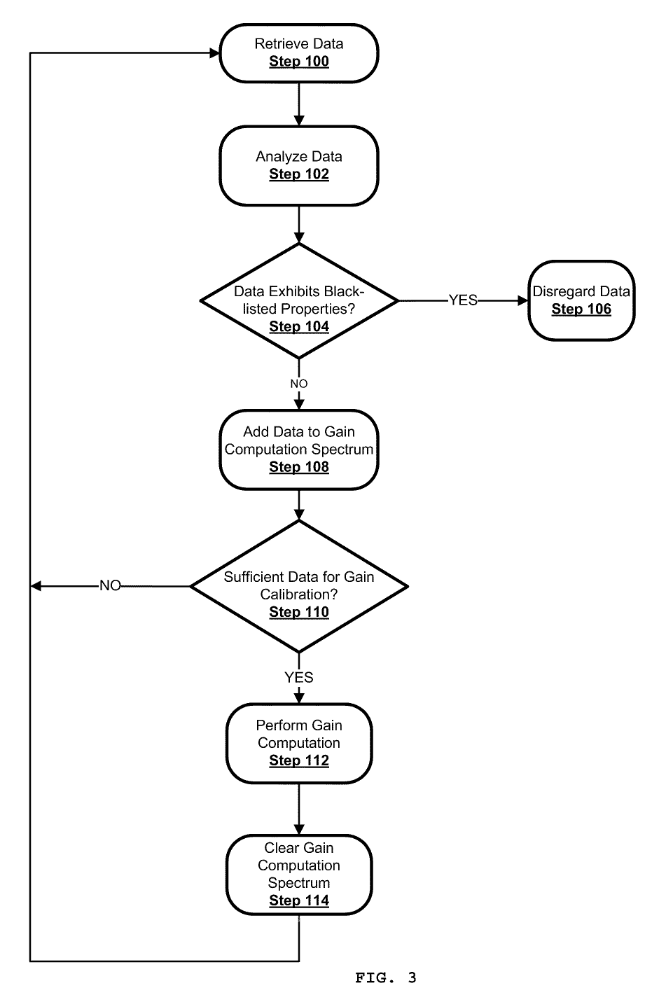

FIG. 3 illustrates an exemplary flow diagram for carrying out detector calibration in accordance with an embodiment of the present invention. In Step 100, the data that is collected by the MCA is retrieved. The information associated with the captured energy gamma ray energies may reside locally on a memory buffer of the MCA. This information may be retrieved at predetermined time intervals (hereinafter referred to as “accumulation intervals”) for further analysis. Additionally, or alternatively, the MCA data may be transferred to another location for further analysis and/or storage. According to one example embodiment of the present invention, 5-second accumulation intervals may be used to allow the retrieval of collected information for a relatively short time period. The retrieved information may be stored on a server and/or placed in a memory device that is accessible for further analysis. Furthermore, the retrieval may be carried out using a variety of well-known data transmission methods, including wired and wireless transmission techniques. The MCA channels may then be cleared to allow the collection of additional gamma ray information.

While the exact value of an accumulation interval may be adjusted based on the particular requirements and logistical needs of a detection system, having a relatively short accumulation interval facilitates uninterrupted operation of the detection device. For example, in a crane-mounted detection system that is used to inspect cargo containers, the collection of data from a relatively short accumulation interval may be accommodated during detector idle times and/or in between crane movements. It should be noted, however, that data accumulation may persist during the normal operation of the detector, as well. As will be described herein with further detail, having a relatively short accumulation interval also enables the identification and rejection of transient and/or anomalous data, which may not be readily identifiable if longer-term accumulation intervals are used.

In Step 102, the collected data is analyzed to determine whether or not it conforms to a set of data selection criteria for gain stabilization and calibration purposes. Step 102 is performed to allow the exclusion of some or all of the data with anomalous features and/or data that exhibit blacklisted properties, as well as for allowing the inclusion of data that exhibit white-listed properties. Black-listed properties refer to the detected properties that may interfere and/or distort the spectral characteristics associated with one or more spectral features of the background radiation that are used to effect detector calibration. Examples of such anomalous characteristics include, but are not limited to, one or more of the following: (a) the spectrum associated with the collected data contains known nuclides that may interfere with the gain stabilization procedure, (b) data has excessive or abnormal gamma count rates, (c) data has excessive or abnormal neutron count rates, or (d) data has unidentified yet anomalous features (e.g. unidentified anomalies with statistically significant peak(s) in data). It should be noted that an abnormal count may include counts that are too high, too low and/or do not conform to expected count values. White-listed properties, on the other hand, refer to the detected properties that do not interfere and/or distort the spectral characteristics associated with one or more spectral features of the background radiation that are utilized to effect detector calibration. For example, white-listed properties may include, but are not limited to, spectral features associated with ubiquitous and/or common nuclides, and gamma count rates and/or neutron count rates that are within an acceptable range. Because the set of possible nuclides to be identified in any detection system may be relatively small (e.g., less than 30), a white list may be produced to designate a subset of such nuclides for inclusion, despite producing, for example, an abnormally high gamma ray count. As such, the implementation of a white list in conjunction with a black list may allow the inclusion of some collected information that may have been strictly excluded in the absence of the white-listing feature.

The presence of anomalous gamma ray energy counts and/or spectral features may be attributed to one or more of the following. First, due to energy resolution characteristics of Sodium Iodide detectors, energy peaks associated with nuclides other than K40 may produce interfering spectral characteristics, created by overlapping peaks that partially interfere with K40 measurements results. Cobalt 60, with energy peaks at 1137 and 1332 keV, and the decay daughters of Uranium 238 (i.e., Bi-214 energy peaks at 1377, 1402, 1408 keV) are two examples of nuclides that have peaks that overlap with K40 measurements to some extent. If the relative abundance of these nuclides with interfering spectral characteristics is significant when compared to K40, the K40 peak region may be distorted, resulting in a systematic error in detector gain calibration. Presence of radioactive gamma-emitting cargo may be one reason for high gamma counts that overwhelm the K40 peak. In such a scenario, a combination of the isotopic content of the cargo coupled with shielding causes Compton scattering. Compton scattering of gammas produces a continuum of counts below the original energy of the scattered gamma. The effect is to shift the gamma counts that are normally outside of the K40 peak region into this region, thus increasing the overall background radiation level and statistical uncertainty in K40 peak measurements.

Furthermore, cargo containing a neutron source, such as oil well logging equipment, may also cause excessive gamma count rates that interfere with gain calibration. Neutrons emitted by neutron sources activate other material, such as Hydrogen and Iron, which may be located in their vicinity, or interact directly with the detector material, producing activation gammas that may then be measured by the detector. If the strength of the neutron source is sufficiently high, the resulting background radiation rate may overwhelm any K40 counts in the spectrum, further complicating the calibration process that is based on properly locating the naturally occurring K40 peak. In accordance with an embodiment of the present invention, to mitigate the effects of these and other interfering sources, some or all of collected data that exhibit features consistent with interfering radiation may be black-listed (or not white-listed) and excluded from the dataset that is used for calibration purposes. Furthermore, some or all data that shows excessive count rates may be excluded from use in gain stabilization. Data with excessive gamma counts from neutrons may also be rejected based on gross gamma counts alone and/or based on the detection or identification of the 2.2 MeV energy peak that is associated with Hydrogen. In accordance with another example embodiment of the present invention, if one is particularly concerned with the interference due to neutron activation, one may also include neutron count rates as another criterion for accepting and/or rejecting some or all of collected data for gain calibration. However, if only gain calibration for gamma detectors is desired, it may not be necessary to incorporate neutron count rates into the data selection criteria for gain calibration.

Referring back to FIG. 3, if the presence of black-listed properties are detected in Step 104, the collected data is disregarded in Step 106. If the data does not exhibit black-listed properties and/or exhibits white-listed properties, the data is retained and is added to gain computation spectrum in Step 108. In accordance with another example embodiment of the present invention, the various thresholds for black-listing and/or white-listing may be fine-tuned to accommodate continuous detector operations in a certain environment, such as a seaport. As such, the thresholds for black-listing and/or white-listing are ultimately determined by the user based on the particular application of the detection system. In one exemplary embodiment, the thresholds for blacklisting/white-listing may be the same values as the thresholds used for the detection of nuclides during normal operation of the detector. These thresholds may be obtained upon analyzing large samples of 5-second background reads (e.g., more than 50,000 accumulation intervals). The threshold may then be determined by finding the value at which only, for example, 1/10,000 of the samples have a value that is greater than the threshold. This 1/10,000 level may be used as the detection and/or alarm threshold. According to another example aspect of the present invention, the above-described thresholds may be varied individually for each nuclide. Furthermore, the thresholds may be varied dynamically based on the collected historical data.

Returning to the flow diagram of FIG. 3, in Step 110, it is determined if sufficient data has been collected for performing detector gain calibration. This task may be accomplished by requiring a minimum time period for data collection and/or setting a minimum target threshold count for the collected data. By the way of example, and not by limitation, the minimum time period may span a duration between 5 to 10 minutes (i.e., 60 to 120 5-second accumulation intervals). This duration enables the collection of enough data points to allow valid statistical analysis of the collected data. Additionally, or alternatively, the collected data may be assessed by fitting the data to an appropriate distribution. This process, which is described herein in further detail, produces a “goodness of fit” that may be used to assess the sufficiency and validity of the collected data. If sufficiency of data is not established, the flow diagram of FIG. 3 returns to Step 100 to retrieve additional data. However, if sufficient data is present, gain computation is performed in Step 112. Finally, in Step 114 the gain computation spectrum may be cleared to allow a new cycle of gain calibration procedure.

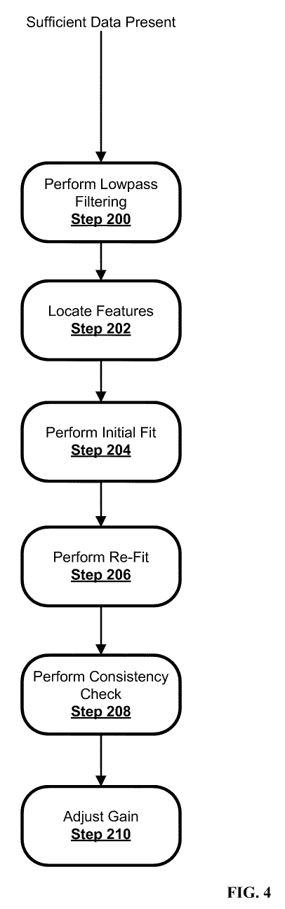

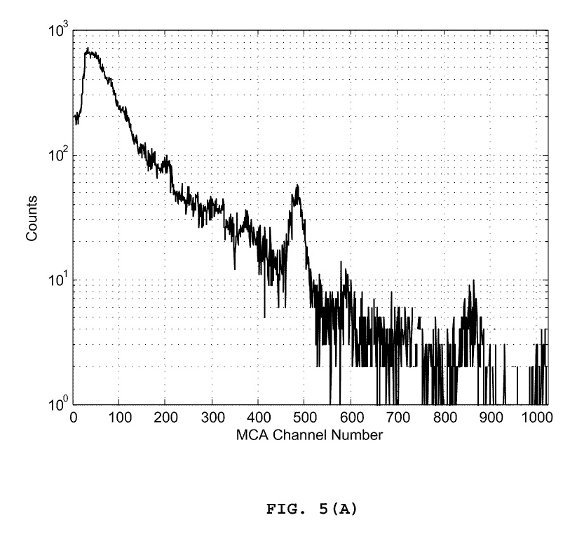

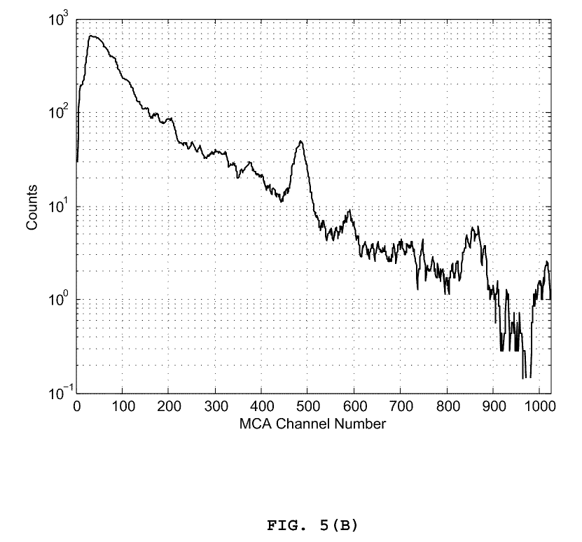

FIG. 4 illustrates the various exemplary steps that may be used to carry out gain computation (i.e., Step 112 of FIG. 3) and gain adjustment in accordance with an example embodiment of the present invention. In Step 200, the collected data is low-pass filtered to remove high frequency components and to facilitate data fitting operations that are performed in subsequent steps. In particular, low-pass filtering removes statistical spikes that may be mistakenly recognized as local maxima, thus enhancing the reliability of the calibration procedure and improving the overall speed of the gain computation procedures. While in an example embodiment of the present invention low-pass filtering is carried out using a 7-point moving average, it is understood that other low-pass filter configurations and/or noise suppression techniques may be readily used to effect the filtering of data in Step 200. The effects of data smoothing are illustrated in FIG. 5(A) and 5(B). FIG. 5(A) illustrates the gain spectrum of an unfiltered collection of data, and FIG. 5(B) illustrates the collected data spectrum after low-pass filtering. As evident from the comparison of FIGS. 5(A) and 5(B), the number of spikes in the energy spectrum has been dramatically reduced after low-pass filtering.

Referring back to FIG. 4, in Step 202, the low-pass filtered version of the accumulated data spectrum is searched in order to locate the specific feature of interest, such as the K40 peak feature that was depicted in FIG. 2(A). According to an example embodiment of the present invention, Step 202 may be carried out by starting from the rightmost end of the energy spectrum (i.e., the highest energy region) and determining the highest point within a window that spans a portion of the spectrum. The size of this window may be user-defined. Operationally, the window may be positioned between channel 450 and channel 1000 for an MCA with 1024 channels. This selection may facilitate the computations by positioning the K40 peak roughly in the center of the energy spectrum. Next, the highest point within the window that corresponds to a local maximum is located. In one example, with the upper bound of the window fixed (e.g., to channel 1000), the lower bound may be extended to lower channels until a local maximum is found. Alternatively, the local maximum may be obtained by fixing the lower bound at a low channel and extending the upper bound of the window. In yet another alternative, both the upper and lower bounds may be increased until a local maximum is obtained. While the above-described specific techniques may be used to suitably locate the K40 peak within the spectrum of collected data, it is understood that other feature location techniques that are known in the art may be readily used to locate one or more features of the energy spectrum.

In Step 204, the located features are fitted to appropriate distributions that approximate the particular features of interest. In accordance with an example embodiment of the present invention, the local maximum obtained from Step 202 is fitted to a distribution comprising a Gaussian foreground distribution and an exponential background distribution. While Step 204 provides an initial fit for the identified features, further refinements may be carried out in subsequent steps to provide improve the accuracy of the fit. In particular, in Step 206, the parameters estimated from the initial fit are taken as constraints for conducting a re-fit. The re-fit is performed on the original, unsmoothed data and the parameters obtained from the re-fit are compared to the same parameters obtained from the initial fit. In effect, Step 206 is carried out to ascertain any appreciable uncertainties in the fit parameters due to the data smoothing operations of Step 200 that may have altered statistical properties of the data.

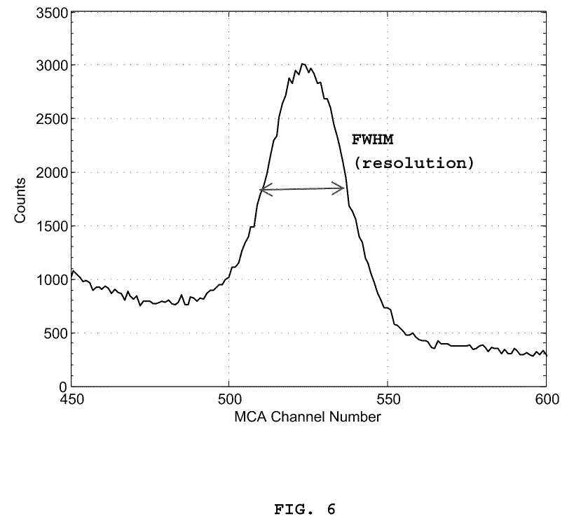

The full-width at half-maximum (FWHM) associated with the peak feature is one exemplary parameter of the peak fitting procedure. FIG. 6 illustrates the FWHM associated with the K40 peak feature that is depicted in the dashed box of FIG. 2(A). While the FWHM may be determined during each gain computation cycle, the uncertainty in such computations may be high, thus requiring the collection of additional data. For example, while it may suffice to collect only 10 minutes of data to obtain a 1% uncertainty in estimating the centroid of the Gaussian fit to the K40 peak, it may take about 100 minutes of data to obtain the same level of uncertainty in the estimated FWHM value. To achieve an acceptable level of uncertainty in the FWHM value, gain computation spectra may be aggregated over several days in order to determine the true FWHM of the detector. The FWHM may be reported, for example, on a daily basis as a measurement of the width parameter for the trailing nine calendar days. In accordance with an example embodiment of the present invention, the FWHM is calculated from all data from properly calibrated spectrum in the previous nine days. The accumulation of nine days worth of properly calibrated data reduces the statistical uncertainty associated with the FWHM parameter, allowing a more meaningful evaluation of the collected results.

One of the features associated with using a controlled radiation source for calibrating gamma ray detectors is that a controlled source can be designed to present striking and thus more easily distinguished features than relatively weak background signals might present. In one embodiment of the present invention, this advantage may be offset by checking the consistency of known relationships between two or more less prominent spectral features, in order to mitigate the possibility of misidentification of any one feature. For example, a valid background spectrum should exhibit an energy peak at 2.61 MeV corresponding to the Thallium 208 nuclide, at 1.79 times the energy of the K40 peak (at 1.46 MeV). According to an exemplary embodiment of the present invention, the consistency check may comprise an attempt to fit an appropriate distribution to the spectrum with a centroid at 1.79 times the channel offset (from zero) of the centroid of a candidate fit to K40. If the fit cannot be performed within a pre-determined tolerance to error, the consistency check fails, and the location of the K40 peak may be deemed uncertain. The error tolerance may be configured as a user-selectable parameter, which may be modified in accordance with various system design and/or practical considerations. Several such consistency checks may be performed in Step 208.

Referring back to FIG. 4, the detector gain may be adjusted to properly calibrate the detector in Step 210. This step may be carried out, for example, by calculating the centroid of the Gaussian peak that is obtained from fitting the K40 data, and comparing it to the location where the centroid should reside. As evident from the example energy spectrum of FIG. 2(B), the centroid should be located around 1461 keV. If the estimated centroid is not within a prescribed number of standard deviations from the desired location, the electronic fine gain of the detector may be adjusted to move the centroid (and thus the K40 peak) to the desired location. For example, this prescribed number may be the greater of 0.5% or two standard deviations. The following exemplary values may facilitate the understanding of gain adjustment procedures that may be carried out in Step 210. If the estimated centroid location associated with the fitted K40 peak is 500 and the desired location of the centroid is at 505, the detector gain may be adjusted by [505−500]/500 or 1% to shift the peak to channel 505. The gain adjustment may be performed under the control of software and/or hardware components that automatically adjust the gain of the detector. It should be noted that upon a failure to locate the desired features (in Step 202), a failure to obtain a proper fit (in Step 204), a proper refit (in Step 206), or a failure of consistency check (Step 208), the gain computation process may return to Step 100 of FIG. 3 to retrieve more data and repeat the subsequent steps.

Another method for adjusting the detector gain may involve making the appropriate gain adjustments through various software and data processing techniques rather than making physical gain adjustments on the detector. For example, gain adjustments may be effected by rebinning the collected data. Rebinning involves redistributing counts in channels from the sampling domain to the domain of choice. In the previous example, where the fitted K40 peak is at channel 500 and the desired peak position is at channel 505, the sampling domain is the domain in which the measurement was performed, while the domain of choice has a K40 peak that is centered at channel 505. Another example technique for making gain adjustments may include accounting for some or all detector gain deviations by simply reporting the position of the K40 peak along with the collected data, so that energy scale corresponding to the data is known for subsequent analyses.

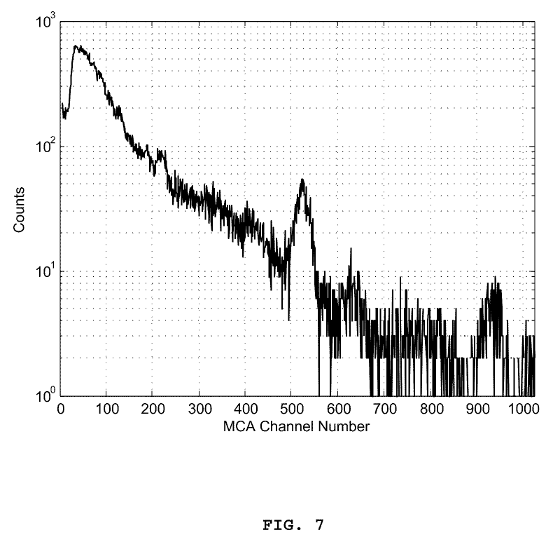

FIG. 7 illustrates an exemplary energy spectrum obtained from a detector that has been calibrated in accordance with the various embodiments of the present invention. Comparing the energy spectrum of FIG. 7 with the un-calibrated energy spectrum of FIG. 5(A) reveals that the K40 peak has been properly shifted to about channel 523 from its initial location below channel 500 in the un-calibrated spectrum of FIG. 5(A).

On occasion, unfavorable statistics may obscure the features of the background spectrum needed to ascertain the current gain. According to one example embodiment of the present invention, the most recent gain determination is presumed to remain an accurate characterization of the detector state and the detector is assumed to continue to provide accurate results, unless one or more conditions or events occur that might cause the gain to shift. Examples of such conditions or events may include, but are not limited to, voltage change, ambient temperature shift that surpasses a threshold value, excessive shock to the detector, and/or elapse of a configurable duration of time since the most recent gain determination. If the most recent gain characterization cannot be presumed to remain accurate due to one or more of the above-noted events, the gain setting may be designated unstable until the next time gain is successfully deemed stable as described below.

Another important aspect of detector operation is detector stability. In accordance with an example embodiment of the present invention, the detector is considered stable if two consecutive measurements that are carried out according to Steps 100 to 114 produce centroids that are within a specified tolerance of each other. For example, such a tolerance may be the greater of 3% or 2 standard deviations. It should be noted that the produced centroids are associated with the detector gain and may be used to effect detector gain adjustments. If the suggested adjustment in the detector gain is within a specified tolerance, the detector may be considered stable, and the gain on the detector may be adjusted accordingly. However, if the suggested adjustment in the detector gain is larger than the specified tolerance, the detector may be considered unstable until two consecutive centroid measurements return values within the specified tolerance. If, after several measurements, the suggested detector gain adjustments still fall outside the specified tolerance, the detector may be considered unstable and may need to be replaced and/or repaired. The above-described assessment of detector stability may be performed, for example, when the detector is initially powered and warming up.

It is understood that the various embodiments of the present invention may be implemented individually, or collectively, in devices comprised of various hardware components and/or software modules. These devices, for example, may comprise a processor, a memory unit, an interface that are communicatively connected to each other. These devices may additionally or alternatively be implemented as hardware components that are capable of performing the various steps associated with the embodiments of the present invention. These components may, for example, be part of a commercially available instrument, or may be implemented using custom-designed circuit boards with Integrated Circuits and/or discrete components. Theses devices and constituent components include, but are not limited to, analyzers, comparators, fitting means, adjustment means, low-pass filters, receivers, calibrators, other devices that may be configured to receive the information collected by one or more gamma-ray detectors, and perform subsequent analysis, fitting, comparing, adjusting or other actions that are necessary to effect the various embodiments of the present invention. Furthermore, while the various embodiments of the present invention may be implemented as a single instrument or apparatus that is, for example, situated on a crane used for moving cargo containers, at least one or more components associated with the various embodiments of the present invention may reside at a different location or multiple locations. For example, while one or more gamma ray detectors and certain other components may reside on a cargo crane, all or part of the data collected by the detector may be transmitted to a different location for analysis. The transmission of data may be effected using a variety of well-known data transmission methods and apparatus, which, by the way of example and not by limitation, include wired and wireless transmission methods and means.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems and computer program products.

What is claimed is:

1. A method for calibrating a gamma ray detector, comprising:
receiving information corresponding to gamma ray energies collected by the detector from background radiation;
analyzing the information to determine if black-listed properties are present, and if one or more black-listed properties are present, disregarding some or all the information;
comparing an energy spectrum associated with the information with one or more spectral features associated with the background radiation; and
calibrating the detector in accordance with the comparing.

2. The method of claim 1, wherein the background radiation comprises a spectral feature associated with Potassium-40 nuclide.

3. The method of claim 1, wherein the information comprises at least one of a count or an intensity value.

4. The method of claim 1, wherein the feature comprises a spectral peak at 1461 keV.

5. The method of claim 1, wherein the detector is configured to operate with a crane that is configured to move containers.

6. The method of claim 1, wherein the black-listed properties comprise at least one of:
one or more spectral features associated with one or more known nuclides with interfering spectral characteristics;
an anomalous gamma count rate;
an anomalous neutron count rate; and
a spectral peak feature not associated with known nuclides.

7. The method of claim 6, wherein the one or more known nuclides comprise Cobalt-60 and decay daughters of Uranium-238.

8. The method of claim 6, wherein the presence of the black-listed properties is determined in accordance with one or more user-defined thresholds.

9. The method of claim 1, further comprising analyzing the information to determine if white-listed properties are present, and if one or more white-listed properties are present, retaining the information.

10. The method of claim 1, further comprising:
fitting the information to one or more statistical distributions to obtain one or more parameters associated with the fitted distribution; and
adjusting a gain of the detector if at least one parameter associated with the fitted distribution is more than a predetermined number of standard deviations from a parameter associated with the spectral feature.

11. The method of claim 10, wherein the parameter associated with the fitted distribution comprises a centroid, and the parameter associated with the spectral feature comprises a location of a peak.

12. The method of claim 10, wherein the statistical distribution comprises a Gaussian foreground distribution and an exponential background distribution.

13. The method of claim 10, further comprising:
producing filtered information by low-pass filtering the information prior to the fitting;
fitting the filtered information to one or more statistical distributions to obtain an initial fit;
fitting the information in accordance with one or more parameters associated with the initial fit to obtain re-fitted information; and
confirming validity of the one or more parameters associated with the initial fit by verifying that differences between the one or more parameters associated with the initial fit and the one or more parameters associated with the re-fitted information are within pre-determined uncertainty bounds.

14. The method of claim 13, further comprising performing one or more consistency checks to confirm the existence one or more relationships between one or more additional features of the background radiation and the fitted distribution.

15. The method of claim 10, wherein the at least one parameter associated with the fitted distribution comprises a full-width at half-maximum value.

16. The method of claim 1, further comprising:
fitting the information to one or more statistical distributions to obtain a first gain value associated with the fitted distribution;
receiving new information corresponding to gamma ray energies collected by the detector from the background radiation;
fitting the new information to the one or more statistical distributions to obtain a second gain value associated with the newly fitted distribution; and
confirming stability of the detector if a difference between the first and the second gain values is within a predetermined tolerance.

17. The method of claim 16, wherein the new information comprises at least one of a count or an intensity value.

18. An apparatus for calibrating a gamma ray detector, comprising:
a receiver configured to receive information corresponding to gamma ray energies collected by the detector from background radiation;
an analyzer configured to analyze the information to determine if black-listed properties are present, and if one or more black-listed properties are present, disregarding some or all the information;
a comparator configured to compare an energy spectrum associated with the information with one or more spectral features associated with the background radiation; and
calibration means configured to calibrate the detector in accordance with the comparator output.

19. The apparatus of claim 18, wherein the comparator is configured to compare the energy spectrum associated with the information with a spectral feature associate with Potassium-40 nuclide.

20. The apparatus of claim 18, wherein the receiver is configured to receive at least one of a count or an intensity value.

21. The apparatus of claim 18, wherein the comparator is configured to compare the energy spectrum associated with the information with a spectral peak at 1461 keV.

22. The apparatus of claim 18, wherein the detector is configured to operate with a crane configured to move containers.

23. The apparatus of claim 18, wherein the analyzer is configured to analyze the black-listed properties comprising at least one of:
one or more spectral features associated with one or more known nuclides with interfering spectral characteristics;
an anomalous gamma count rate;
an anomalous neutron count rate; and
a spectral peak feature not associated with known nuclides.

24. The apparatus of claim 23, wherein the analyzer is configured to analyze the black-listed properties comprising one or more spectral features associated with Cobalt-60 and decay daughters of Uranium-238.

25. The apparatus of claim 23, wherein the analyzer is configured to determine the presence of the black-listed properties in accordance with one or more user-defined thresholds.

26. The apparatus of claim 18, wherein the analyzer is further configured to analyze the information to determine if white-listed properties are present, and if one or more white-listed properties are present, retaining the information.

27. The apparatus of claim 18, further comprising:
fitting means configured to fit the information to one or more statistical distributions to obtain one or more parameters associated with the fitted distribution; and
adjustment means configured to adjust a gain of the detector if at least one parameter associated with the fitted distribution is more than a predetermined number of standard deviations from a parameter associated with the spectral feature.

28. The apparatus of claim 27, wherein the adjustment means is configured to adjust the gain if a centroid associated with the fitted distribution is more than a predetermined number of standard deviations from a location of a peak associated with the spectral feature.

29. The apparatus of claim 27, wherein the fitting means is configured to fit the information to a distribution comprising a Gaussian foreground distribution and an exponential background distribution.

30. The apparatus of claim 27, further comprising:
a low-pass filter configured to produce filtered information;
fitting means configured to:
fit the filtered information to one or more statistical distributions to obtain an initial fit, and
fit the information in accordance with one or more parameters associated with the initial fit to obtain re-fitted information; and
verification means configured to verify that differences between the one or more parameters associated with the initial fit and the one or more parameters associated with the re-fitted information are within pre-determined uncertainty bounds.

31. The apparatus of claim 30, wherein the analyzer is further configured to perform one or more consistency checks to confirm the existence one or more relationships between one or more additional features of the background radiation and the fitted distribution.

32. The apparatus of claim 18, further comprising:
fitting means configured to fit the information to one or more statistical distributions to obtain a first gain value associated with the fitted distribution, wherein:
the receiver is configured to receive new information corresponding to gamma ray energies collected by the detector from the background radiation;
the fitting means is configured to fit the new information to the one or more statistical distributions to obtain a second gain value associated with the newly fitted distribution; and
the comparator is configured to compare a difference between the first and the second gain values to a predetermined tolerance.

33. A computer program product, embodied on a computer-readable medium, for calibrating a gamma ray detector, comprising:
a computer program for receiving information corresponding to gamma ray energies collected by the detector from background radiation;
a computer program for analyzing the information to determine if black-listed properties are present, and if one or more black-listed properties are present, disregarding some or all the information;
a computer program for comparing an energy spectrum associated with the information with one or more spectral features associated with the background radiation; and
a computer program for calibrating the detector in accordance with the comparing.
